(19) United States
(12) Patent Application Publication
(10) Pub. No.: US 2023/0045246 A1
(43) Pub. Date: Feb. 9, 2023

(54) COMPOSITION FOR PREVENTING TEETH STAINING

(71) Applicants: Andrew Onstad, Manhattan Beach, CA (US); Meline Mirzabegian, Burbank, CA (US)

(72) Inventors: Andrew Onstad, Manhattan Beach, CA (US); Hugo Lisboa, Campina Grande (BR); Meline Mirzabegian, Burbank, CA (US)

(21) Appl. No.: 17/870,294

(22) Filed: Jul. 21, 2022

Related U.S. Application Data
(60) Provisional application No. 63/224,252, filed on Jul. 21, 2021.

(51) Int. Cl. A23L 2/52; A23L 2/44; A23L 2/60; A23F 5/24; C12G 1/00; A23L 27/30; A23L 29/238

(52) U.S. Cl. CPC A23L 2/52; A23L 2/44; A23L 2/60; A23F 5/243; C12G 1/00; A23L 27/34; A23L 29/238; A23V 2002/00; C12G 2200/21

(57) ABSTRACT

The disclosure relates to a beverage additive that contains a complexing agent, a thickening agent, and a preservative and methods of using the beverage additive to prevent teeth staining.

### CROSS-REFERENCE TO RELATED APPLICATIONS

This application claims the benefit of priority to U.S. Application No. 63/224,252, filed on Jul. 21, 2021, the contents of which are hereby incorporated by reference.

### TECHNICAL FIELD

The present disclosure relates to beverage additives that inhibit chromogens from binding to teeth. The beverage additives are useful in preventing teeth staining.

### BACKGROUND

White teeth have long been considered cosmetically desirable, and people will go to great lengths to achieve and/or maintain white teeth. The tooth materials that are generally responsible for presenting a stained appearance are enamel, dentin, and acquired pellicle. In particular, tooth enamel is formed predominantly from inorganic material, mostly in the form of hydroxyapatite crystals, and it further contains approximately 5% organic material, primarily in the form of collagen. Conversely, dentin is composed of about 20% protein, including collagen, with the balance comprising of inorganic material, predominantly hydroxyapatite crystals, similar to that found in enamel. The acquired pellicle, on the other hand, is a proteinaceous layer on the surface of tooth enamel, which reforms rapidly even following an intensive tooth cleaning with highly abrasive prophylaxis pastes.

Tooth discoloration results from both extrinsic and intrinsic staining. Extrinsic staining of the tooth surface arises because of the accumulation of various chromogenic substances (in addition to chromogen precursors, which are initially colorless, but later chemically convert to chromogens) within the acquired pellicle. This type of staining can usually be removed by mechanical methods, which remove the acquired pellicle or portions thereof, along with the adherent chromogens. Aging of extrinsic stains, however, has been known to make the extrinsic stains less susceptible to removal by mechanical means, perhaps due to increased depth of extrinsic stain penetration into enamel over time. Such stains, therefore, require the use of chemicals, such as oxygenating agents, which can penetrate the tooth enamel to oxidize or solubilize the deep-seated chromogens. In contrast, intrinsic staining occurs because of chromogenic substances derived from sources within the tooth. This type of staining is not amenable to mechanical methods of tooth cleaning, and the aforementioned chemical methods are usually required.

While various teeth whitening products and procedures have been developed to whiten teeth, they typically cause the teeth to become dehydrated and porous, making them more prone to staining. Susceptibility to teeth staining can last for several days, or weeks in some cases, after whitening. Accordingly, dental professionals generally advise patients to abstain from consuming pigmented food and drinks after teeth whitening and in general in order to maintain white teeth. Common acidic foods and beverages such as wine, yogurt, and orange juice can also temporarily demineralize or etch the surface of the enamel, thereby making teeth more susceptible to staining.

As avoiding these foods and drinks may prove difficult, there is a need for an additive that can be added to foods and drinks that prevents the teeth from being stained. There is also a need for an additive that can be added to foods and drinks that prevents the teeth from being stained, thereby avoiding the need to use teeth whitening products and procedures.

### SUMMARY

Provided in the present disclosure is a beverage additive. In some embodiments, the beverage additive comprises: about 0.2 wt % to about 10 wt % of a complexing agent; about 0.2 wt % to about 3 wt % of a thickening agent; and about 0.05 wt % to about 2 wt % of a preservative. In some embodiments, the beverage additive inhibits or reduces the binding of a chromogen in a beverage to teeth. In some embodiments, the beverage additive is a food-grade additive. In some embodiments, the beverage additive is added to a beverage containing chromogens.

In some embodiments, the chromogen is present in a beverage selected from the group consisting of wine, coffee, tea, cola soda, and fruit juice. In some embodiments, the chromogen is selected from the group consisting of a tannin, a flavonoid, a proanthocyanidin, an aurone, a chalconoid, a lignan, a phytoestrogen, a stilbenoid, a curcuminoid, a betacyanin, and a betaxanthin. In some embodiments, the chromogen is selected from the group consisting of 1,5-dicaffeoylquinic acid, 2-s-glutathionyl caftaric acid, 3,4-dicaffeoylquinic acid, 3,5-di-affeoylquinic acid, 3-caffeoylquinic-1 5-lactone, 4,5-dicaffeoylquinic acid, 4-O-caffeoylquinic acid, 5-caffeoylquinic acid, 5-O-caffeoylquinic acid, caffeic acid, carminic acid, catechin, chlorogenic acid, cyanidin, cyanidin-3-glucoside, cyaniding-3,5-diglucoside, delphinidin, delphinidin-3,5-diglucoside, delphinidin-3-glucoside, dihydrokaempferol-3-O-α-L-rhamnopyranoside, dihydroquercetin-3-O-α-L-rhamnopyranoside, ellagic acid, epicatechin gallate, epigallocatechin, epigallocatechin gallate, gallic acid, gallocatechol, hexahydroxydiphenic acid, isorhamnetin-3-O-β-D-glucopyranoside, malvidin, malvidin-3,5-diglucoside, malvidin-3-glucoside, myricetin, oenin, pedunculagin, pelargonidin, pelargonidin-3,5-diglucoside, pelargonidin-3-glucoside, peonidin, petunidin, phenylcarboxylic acid, polyhydric alcohol, punicalagin, punicalin, quercetin, quercetin-3-O-β-D-galactopyranoside, quercetin-3-O-β-D-glucuropyranoside, resveratrol, rutine, syringetin-3-O-β-D-glucopyranoside, tannic acid, theaflavin, theaflavin-3,3-digallate, theaflavin-3-gallate, and theasinensin A. In some embodiments, the chromogen is a tannin.

In some embodiments, the beverage additive binds to the tannins present in the beverage. In some embodiments, the tannins are gallic acid-derived, phlorogluncinol-derived, or flavan-3,4-diol-derived.

In some embodiments, the complexing agent is an inorganic salt or an organic salt. In some embodiments, the complexing agent is selected from the group consisting of tricalcium phosphate, dicalcium phosphate, calcium chloride, calcium carbonate, sodium phosphate, sodium chloride, sodium bicarbonate, sodium tripolyphosphate, magnesium chloride, potassium chloride, citric acid, malic acid, lactic acid, acetic acid, phosphoric acid, hydrochloric acid, hydroxide sodium, iron (III) chloride, and combinations thereof. In some embodiments, the complexing agent is selected from the group consisting of magnesium chloride, tricalcium phosphate, sodium tripolyphosphate, and combinations thereof. In some embodiments, the beverage additive comprises about 0.5 wt % to about 7 wt % complexing agent. In some embodiments, the beverage additive comprises about 1.0 wt %, about 1.5 wt %, or about 6.4 wt % complexing agent.

In some embodiments, the thickening agent is a polysaccharide. In some embodiments, wherein the thickening agent is selected from the group consisting of guar gum, xantham gum, gellan gum, konjac mannan, arabic gum, hydropropymethyl cellulose, carboxymethyl cellulose, methyl cellulose, chitosan, alginate, carrageenan, and combinations thereof. In some embodiments, the thickening agent is guar gum. In some embodiments, the beverage additive comprises about 0.5 wt % to about 2 wt % thickening agent. In some embodiments, the beverage additive comprises about 0.5 wt %, about 1.0 wt %, or about 1.8 wt % thickening agent.

In some embodiments, the preservative is selected from the group consisting of potassium sorbate, sodium benzoate, sodium chloride, benzoic acid, calcium sorbate, erthorbic acid, potassium nitrate, and combinations thereof. In some embodiments, the preservative is selected from the group consisting of potassium sorbate, sodium benzoate, sodium chloride, and combinations thereof. In some embodiments, the beverage composition comprises about 0.3 wt % to about 0.4 wt % preservative.

In some embodiments, the beverage additive further comprises water. In some embodiments, the water is distilled water. In some embodiments, the beverage additive comprises about 80 wt % to about 99.5 wt % water. In some embodiments, the beverage additive comprises about 90 wt % to about 97 wt % water. In some embodiments, the beverage additive comprises about 91.2 wt % or about 96.7 wt % water.

In some embodiments, the beverage additive further comprises a sweetener. In some embodiments, the sweetener is selected from the group consisting of potassium acesulfame, sucralose, allulose, cane sugar, brown sugar, molasses, stevia, sorbitol, mannitol, xylitol, lactitol, maltitol, isomalt, laycasin, and combinations thereof. In some embodiments, the sweetener is selected from sorbitol, potassium acesulfame, and a combination thereof. In some embodiments, the beverage additive comprises about 0.05 wt % to about 2.0 wt % sweetener. In some embodiments, the beverage additive comprises about 0.2 wt % to about 1.0 wt % sweetener.

Also provided in the present disclosure is a beverage additive comprising: about 0.5 wt % to about 7.0 wt % of a complexing agent selected from the group consisting of magnesium chloride, tricalcium phosphate, sodium tripolyphosphate, and combinations thereof; about 0.3 wt % to about 2.5 wt % of a thickening agent; about 0.1 wt % to about 1 wt % of a preservative selected from the group consisting of potassium sorbate, sodium benzoate, sodium chloride, and combinations thereof; about 90.0 wt % to about 98.0 wt % water; and about 0.1 wt % to about 1.5 wt % of a sweetener selected from the group consisting of sorbitol, potassium acesulfame, and combinations thereof.

In some embodiments, the beverage additive comprises about 1 wt % magnesium chloride, about 1 wt % guar gum, about 0.1 wt % potassium sorbate, about 0.1 wt % sodium benzoate, about 0.1 wt % sodium chloride, and about 1 wt % sorbitol. In some embodiments, the beverage additive comprises about 96 wt % to about 97 wt % distilled water.

In some embodiments, the beverage additive comprises about 1 wt % tricalcium phosphate, about 1 wt % guar gum, about 0.1 wt % potassium sorbate, about 0.1 wt % sodium benzoate, about 0.1 wt % sodium chloride, and about 1 wt % sorbitol. In some embodiments, the beverage additive comprises about 96 wt % to about 97 wt % distilled water.

In some embodiments, the beverage additive comprises about 1 wt % sodium tripolyphosphate, about 1 wt % guar gum, about 0.1 wt % potassium sorbate, about 0.1 wt % sodium benzoate, about 0.1 wt % sodium chloride, and about 1 wt % sorbitol. In some embodiments, the beverage additive comprises about 96 wt % to about 97 wt % distilled water.

In some embodiments, the beverage additive comprises about 0.5 wt % magnesium chloride, about 0.5 wt % tricalcium phosphate, about 0.5 wt % sodium tripolyphosphate, about 0.5 wt % guar gum, about 0.1 wt % potassium sorbate, about 0.1 wt % sodium benzoate, about 0.1 wt % sodium chloride, and about 1 wt % sorbitol. In some embodiments, the beverage additive comprises about 96 wt % to about 97 wt % distilled water.

In some embodiments, the beverage additive comprises about 0.9 wt % tricalcium phosphate, about 5.5 wt % sodium tripolyphosphate, about 1.8 wt % guar gum, about 0.4 wt % sodium benzoate, and about 0.2 wt % potassium acesulfame. In some embodiments, the beverage additive comprises about 91 wt % to about 92 wt % distilled water.

In some embodiments, the beverage additive further comprises a pH modifier.

Also provided in the present disclosure is a method of inhibiting chromogen binding to teeth from beverage consumption in a subject. In some embodiments, the method comprises adding the beverage additive of the present disclosure to a beverage containing chromogens, and consuming the beverage comprising the beverage additive by the subject. In some embodiments, the beverage is selected from the group consisting of wine, coffee, tea, cola soda, and fruit juice. In some embodiments, the beverage additive is added in an amount of about 0.05% to about 6.0% of the beverage by volume.

Also provided in the present disclosure is a beverage composition. In some embodiments, the beverage composition comprises a beverage comprising chromogens and a beverage additive of the present disclosure. In some embodiments, the beverage additive does not change the color, aroma, or flavor of the beverage as compared to the same beverage that does not contain the beverage additive. In some embodiments, the beverage additive comprises about 0.05% to about 6.0% of the beverage composition by volume. In some embodiments, the beverage additive comprises about 3% to about 4% of the beverage composition by volume. In some embodiments, the beverage additive comprises about 3.3% of the beverage composition by volume. In some embodiments, the beverage composition does not stain teeth.

Also provided in the present disclosure is a method of preparing a beverage composition. In some embodiments, the method includes adding a beverage additive of the present disclosure to a beverage comprising chromogens to form a beverage composition. In some embodiments, the beverage additive comprises about 0.05% to about 6.0% of the beverage composition by volume. In some embodiments, the beverage comprising chromogens is selected from the group consisting of wine, coffee, tea, cola soda, and fruit juice. In some embodiments, the beverage composition inhibits or reduces staining of teeth by the chromogens.

Other features and advantages of the processes, formulations, and uses provided herein will be apparent from the following detailed description and figures, and from the claims.

### BRIEF DESCRIPTION OF DRAWINGS

FIG. 1 shows the evolution of color variation on the CIELAB color space from the natural teeth to teeth immersed in red wine and different stain prevention additives over 96 hours.

FIG. 2 shows the evolution of color variation on the CIELAB color space from the natural teeth to teeth immersed in coffee and different stain prevention additives over 96 hours.

FIG. 3 shows the evolution of color variation on the CIELAB color space from the natural teeth to teeth immersed in red wine and different volumes of stain prevention additive over 96 hours.

FIG. 4 shows the evolution of color variation on the CIELAB color space from the natural teeth to teeth immersed in red wine and different volumes of stain prevention additive over 96 hours.

### DETAILED DESCRIPTION

Provided herein are beverage additives that inhibit or reduce the binding of chromogens in beverages to teeth. In some embodiments, the beverage additives inhibit or reduce staining of teeth, for example, the teeth of a subject that consumes a chromogen-containing beverage that contains the beverage additive.

### Definitions

Unless otherwise defined, all technical and scientific terms used herein have the same meaning as commonly understood by one of ordinary skill in the art to which this disclosure belongs. Methods and materials are described herein for use in the present disclosure; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

In this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about” as used herein can allow for a degree of variability in a value or range, for example, within 10%, within 5%, or within 1% of a stated value or of a stated limit of a range. The term “chromogen,” as used herein, means a compound that when deposited on a surface, e.g., a tooth, causes coloration of the surface. The term also encompasses chromogen precursors, which can chemically convert to chromogens. Exemplary chromogens include, but are not limited to, tannins, flavonoids, proanthocyanidins, aurones, chalconoids, lignans, phytoestrogens, stilbenoids, curcuminoids, betacyanins, and betaxanthins.

The term “tannin,” as used herein, refers to polyphenolic biomolecules. Tannins are astringent, bitter plant polyphenolic compounds that bind to and precipitate proteins and various other organic compounds including amino acids and alkaloids. In some embodiments, tannins have molecular weights ranging from about 500 to over 3,000, such as gallic acid esters, and up to about 20,000, such as proanthocyanidins. Tannins, for example, can be found in foods and drinks such as tea, coffee, red wine, cola soda, and fruit juice.

The term “inhibit or inhibiting,” as used herein, means a decrease or reduction in the amount, quality, response, or effect of a particular activity, function, or molecule. In some embodiments, the beverage additives of the present disclosure inhibit binding of a chromogen in the beverage to teeth. In some embodiments, the beverage additives of the present disclosure reduce binding of a chromogen in the beverage to teeth. In some embodiments, the beverage additives of the present disclosure inhibit or reduce binding of chromogens to teeth in a beverage containing the beverage additive after a subject has consumed the beverage that contains chromogens.

As used herein, the term “complexing agent” refers to a salt that can bind to a chromogen. In some embodiments, the binding of the complexing agent to the chromogen inhibits the chromogen from binding to teeth.

An “acidulant,” as used herein, refers to a component that presents an acidic taste. Examples include, but are not limited to, fruit juices extracted from natural ingredients, as well as fumaric acid, phosphoric acid, citric acid, and lactic acid.

An “anti-mold,” as used herein, refers to a component that kills mold and/or inhibits the growth of mold.

### Beverage Additive

Provided in the present disclosure are beverage additives. In some embodiments, the beverage additive contains a complexing agent, a thickening agent, and a preservative. In some embodiments, the composition further comprises one or more additional ingredients, including, but not limited to, water, acidulants, and sweeteners. The beverage additive of the present disclosure can be added to beverages that cause teeth to stain, for example, beverages that contain chromogens. Examples of such beverages include, but are not limited to, red wine, coffee, cola soda, tea, and fruit juice. In some embodiments, addition of the beverage additive of the present disclosure to a beverage containing chromogens inhibits or reduces the binding of a chromogen in the beverage to teeth. In some embodiments, the inhibition or reduction of the binding of the chromogen to teeth prevents staining of the teeth. In some embodiments, a subject that consumes a chromogen-containing beverage that contains the beverage additive of the present disclosure will display teeth that are less stained (i.e., colored) as compared to consuming the same chromogen-containing beverage that does not contain the beverage additive of the present disclosure. In some embodiments, the beverage additives of the present disclosure do not change or alter the taste or appearance of a beverage to which it is added. In some embodiments, the beverage additives of the present disclosure are food-grade additives.

### Complexing Agent

In some embodiments, the beverage additive of the present disclosure includes a complexing agent. The complexing agent can be, for example, an inorganic salt or an organic salt. In some embodiments, the complexing agent contains a cation and an anion.

In some embodiments, the cation of the complexing agent is selected from a magnesium ion, a calcium ion, a sodium ion, a potassium ion, a zinc ion, and a manganese ion.

In some embodiments, the anion of the complexing agent is selected from a chloride ion, a phosphate ion, a polyphosphate ion, a tripolyphosphate ion, a carbonate ion, a chlorate ion, a sulfate ion, a sulfite ion, or an acetate ion.

In some embodiments, the complexing agent is an inorganic salt.

In some embodiments, the complexing agent is selected from the group consisting of tricalcium phosphate, dicalcium phosphate, calcium chloride, calcium carbonate, sodium phosphate, sodium chloride, sodium bicarbonate, sodium tripolyphosphate, magnesium chloride, potassium chloride, citric acid, malic acid, lactic acid, acetic acid, phosphoric acid, hydrochloric acid, hydroxide sodium, iron (III) chloride, and combinations thereof. In some embodiments, the complexing agent is selected from the group consisting of magnesium chloride, tricalcium phosphate, sodium tripolyphosphate, and combinations thereof. In some embodiments, the complexing agent is magnesium chloride. In some embodiments, the complexing agent is tricalcium phosphate. In some embodiments, the complexing agent is sodium tripolyphosphate. In some embodiments, the complexing agent is magnesium chloride, tricalcium phosphate, and sodium tripolyphosphate. In some embodiments, the complexing agent is tricalcium phosphate and sodium tripolyphosphate.

In some embodiments, the complexing agent is guar gum. In some embodiments, the complexing agent is tricalcium phosphate, sodium tripolyphosphate, and guar gum.

In some embodiments, the beverage additive contains about 0.01 wt % to about 10 wt % complexing agent. In some embodiments, the beverage additive contains about 0.2 wt % to about 10 wt % complexing agent. In some embodiments, the beverage additive contains about 0.5 wt % to about 7 wt % complexing agent. In some embodiments, the beverage additive contains about 0.5 wt % to about 8.0 wt %, about 0.7 wt % to about 7.0 wt %, or about 0.9 wt % to about 7.0 wt % complexing agent. In some embodiments, the beverage additive contains about 0.2 wt % to about 5.0 wt %, about 0.5 wt % to about 2.0 wt %, about 0.7 wt % to about 1.5 wt %, or about 1.0 wt % to about 1.5 wt % complexing agent. In some embodiments, the beverage additive contains about 1.0 wt % complexing agent. In some embodiments, the beverage additive contains about 1.5 wt % complexing agent. In some embodiments, the beverage additive contains about 2 wt % to about 10 wt %, about 4 wt % to about 8.0 wt %, or about 5 wt % to about 7 wt % complexing agent. In some embodiments, the beverage additive contains about 6.4 wt % complexing agent.

In some embodiments, the beverage additive contains about 8 wt % complexing agent.

### Thickening Agent

In some embodiments, the beverage additive of the present disclosure includes a thickening agent. Any compound that can increase the viscosity of an aqueous solution can be used in the beverage additives of the present disclosure. In some embodiments, the thickening agent is a polysaccharide. In some embodiments, the thickening agent is selected from the group consisting of a starch, a glycogen, a galactogen, an inulin, an arabinoxylan, a cellulose, a chitin, a pectin, and combinations thereof. In some embodiments, the thickening agent is selected from the group consisting of guar gum, xantham gum, gellan gum, konjac mannan, arabic gum, hydropropymethyl cellulose, carboxymethyl cellulose, methyl cellulose, chitosan, alginate, carrageenan, and combinations thereof. In some embodiments, the thickening agent is guar gum.

In some embodiments, the beverage additive contains about 0.1 wt % to about 10 wt % thickening agent. In some embodiments, the beverage additive contains about 0.1 wt % to about 5 wt % thickening agent. In some embodiments, the beverage additive contains about 0.2 wt % to about 3 wt % thickening agent. In some embodiments, the beverage additive contains about 0.5 wt % to about 2 wt % thickening agent. In some embodiments, the beverage additive contains about 0.3 wt % to about 2.8 wt %, about 0.3 wt % to about 2.5 wt %, or about 0.4 wt % to about 2.0 wt % thickening agent. In some embodiments, the beverage additive contains about 0.6 wt % to about 1.5 wt %, about 0.7 wt % to about 1.4 wt %, or about 0.8 wt % to about 1.2 wt % thickening agent. In some embodiments, the beverage additive contains about 0.2 wt % to about 1.0 wt %, about 0.3 wt % to about 0.8 wt %, or about 0.3 wt % to about 0.6 wt % thickening agent. In some embodiments, the beverage additive contains about 1.0 wt % to about 3.0 wt %, about 1.0 wt % to about 2.5 wt %, or about 1.5 wt % to about 2.0 wt % thickening agent. In some embodiments, the beverage additive contains about 0.5 wt %, about 1.0 wt %, or about 1.8 wt % thickening agent. In some embodiments, the beverage additive contains about 0.5 wt % thickening agent. In some embodiments, the beverage additive contains about 1.0 wt % thickening agent. In some embodiments, the beverage additive contains about 1.8 wt % thickening agent.

### Preservative

In some embodiments, the beverage additive of the present disclosure includes a preservative. In some embodiments, the preservative is selected from the group consisting of potassium sorbate, sodium benzoate, sodium chloride, benzoic acid, calcium sorbate, erthorbic acid, potassium nitrate, sorbic acid, sodium sorbate, sulfur dioxide, lactic acid, propionic acid, ascorbic acid, butylated hydroxyanisole, butylated hydroxytoluene, tert-butylhydroquinone, propyl 3,4,5-trihydroxybenzoate, citric acid, and combinations thereof. In some embodiments, the preservative is selected from the group consisting of potassium sorbate, sodium benzoate, sodium chloride, benzoic acid, calcium sorbate, erthorbic acid, potassium nitrate, and combinations thereof. In some embodiments, the preservative is selected from the group consisting of potassium sorbate, sodium benzoate, sodium chloride, and combinations thereof. In some embodiments, the preservative is potassium sorbate, sodium benzoate, and sodium chloride. In some embodiments, the preservative is sodium benzoate.

In some embodiments, the preservative is an anti-mold agent. In some embodiments, the anti-mold agent is sodium benzoate, potassium sorbate, calcium propionate, sodium metabisulfite, cultured dextrose, or combination thereof. An exemplary cultured dextrose is the cultured dextrose CytoGUARD® CDP Ultra (A & B Ingredients, Inc., Fairfield, N.J.). In some embodiments, the anti-mold agent is cultured dextrose. In some embodiments, the anti-mold agent is CytoGUARD® CDP Ultra.

In some embodiments, the beverage additive contains about 0.05 wt % to about 2 wt % preservative. In some embodiments, the beverage additive contains about 0.08 wt % to about 1.5 wt %, about 0.1 wt % to about 1.0 wt %, or about 0.2 wt % to about 0.5 wt % preservative. In some embodiments, the beverage additive contains about 0.3 wt % to about 0.4 wt % preservative. In some embodiments, the beverage additive contains about 0.3 wt % preservative. In some embodiments, the beverage additive contains about 0.4 wt % preservative.

In some embodiments, the beverage additive contains about 1.0 wt % to about 3.0 wt %, about 1.0 wt % to about 2.0 wt %, or about 1.5 wt % to about 2.0 wt % preservative. In some embodiments, the beverage additive contains about 1.8 wt % preservative.

### Water

In some embodiments, the beverage additive of the present disclosure further contains water. In some embodiments, the water is distilled water. In some embodiments, the beverage additive contains about 80 wt % to about 99.5 wt % water. In some embodiments, the beverage additive contains about 85 wt % to about 99 wt %, about 88 wt % to about 99 wt %, or about 90 wt % to about 97 wt % water. In some embodiments, the beverage additive contains about 93 wt % to about 98 wt % or about 90 wt % to about 92 wt % water. In some embodiments, the beverage additive contains about 90 wt % to about 97 wt % water. In some embodiments, the beverage additive contains about 91 wt % to about 97 wt % water. In some embodiments, the beverage additive contains about 91 wt % to about 92 wt % water. In some embodiments, the beverage additive contains about 96 wt % to about 97 wt % water.

In some embodiments, the beverage additive contains about 88 wt % to about 92 wt % water.

### Acidulant

In some embodiments, the beverage additive of the present disclosure further includes an acidulant. In some embodiments, the acidulant is selected from the group consisting of sodium citrate, citric acid, malic acid, acetic acid, lactic acid, fumaric acid, tartric acid, succinic acid, hydrochloric acid, phosphoric acid, or combination thereof. In some embodiments, the acidulant is sodium citrate, citric acid, malic acid, or combination thereof. In some embodiments, the acidulant is sodium citrate. In some embodiments, the acidulant is citric acid and malic acid. In some embodiments, the acidulant is citric acid. In some embodiments, the acidulant is malic acid.

In some embodiments, the beverage additive contains about 0.05 wt % to about 0.5 wt % acidulant. In some embodiments, the beverage additive contains about 0.08 wt % to about 0.5 wt %, about 0.1 wt % to about 0.5 wt %, or about 0.2 wt % to about 0.4 wt % acidulant. In some embodiments, the beverage additive contains about 0.1 wt %, about 0.2 wt %, or about 0.3 wt % acidulant. In some embodiments, the beverage additive contains about 0.3 wt % acidulant.

### Sweetener

In some embodiments, the beverage additive of the present disclosure further contains a sweetener. In some embodiments, the sweetener is a food-grade sweetener. Any food-grade sweetener that can increase the sweetness of an aqueous beverage can be used in the beverage additives of the present disclosure. In some embodiments, the sweetener is selected from the group consisting of potassium acesulfame, sucralose, allulose, cane sugar, brown sugar, molasses, stevia, sorbitol, mannitol, xylitol, lactitol, maltitol, isomalt, laycasin, saccharin, aspartame, advantame, neotame, cyclamate, mogroside, erythritol, isomalt, glycerol, and combinations thereof. In some embodiments, the sweetener is selected from the group consisting of potassium acesulfame, sucralose, allulose, cane sugar, brown sugar, molasses, stevia, sorbitol, mannitol, xylitol, lactitol, maltitol, isomalt, laycasin, and combinations thereof. In some embodiments, the sweetener is selected from sorbitol, potassium acesulfame, and a combination thereof. In some embodiments, the sweetener is sorbitol. In some embodiments, the sweetener is potassium acesulfame.

In some embodiments, the beverage additive contains about 0.05 wt % to about 2.0 wt % sweetener. In some embodiments, the beverage additive contains about 0.1 wt % to about 1.0 wt % sweetener. In some embodiments, the beverage additive contains about 0.6 wt % to about 1.5 wt %, about 0.7 wt % to about 1.4 wt %, or about 0.8 wt % to about 1.2 wt % sweetener. In some embodiments, the beverage additive contains about 0.08 wt % to about 1.5 wt %, about 0.1 wt % to about 0.5 wt %, or about 0.1 wt % to about 0.3 wt % sweetener. In some embodiments, the beverage additive contains about 0.2 wt % to about 1.0 wt % sweetener. In some embodiments, the beverage additive comprises about 0.2 wt % sweetener. In some embodiments, the beverage additive comprises about 1.0 wt % sweetener.

### Protein

In some embodiments, the beverage additive of the present disclosure further includes a protein. In some embodiments, the protein is selected from the group consisting of potassium casein, legumin, vicilin, α-lactalbumin, β-lactoglobulin, or serum albumin, or combination thereof. In some embodiments, the protein is potassium casein.

In some embodiments, the beverage additive contains about 0.1 wt % to about 1.0 wt % protein, such as about 0.2 wt % to about 0.9 wt %, about 0.5 wt % to about 0.8 wt %, about 0.6 wt % to about 0.9 wt %, or about 0.7 wt % to about 0.9 wt %. In some embodiments, the beverage additive contains about 0.8 wt % protein.

### pH Modifier

In some embodiments, the beverage additive of the present disclosure further includes a pH modifier. Any suitable pH modifier can be used in the beverage additives of the present disclosure. In some embodiments, the pH modifier is an acid. In some embodiments, the pH modifier is a base. In some embodiments, the pH modifier is lactic acid, acetic acid, formic acid, citric acid, oxalic acid, malic acid, tartaric acid, or benzoic acid. In some embodiments, the pH modifier is a lactate salt, acetate salt, formate salt, citrate salt, oxalate salt, maleate salt, tartrate salt, or benzoate salt. In some embodiments, the pH modifier is sodium bicarbonate, ammonium bicarbonate, potassium bicarbonate, or calcium carbonate. In some embodiments, the pH modifier is sodium bicarbonate.

In some embodiments, the beverage additive contains about 0.1 wt % to about 1.0 wt %, about 0.2 wt % to about 0.9 wt %, about 0.5 wt % to about 0.8 wt %, about 0.6 wt % to about 0.9 wt %, or about 0.7 wt % to about 0.9 wt % pH modifier. In some embodiments, the beverage additive contains about 0.9 wt % pH modifier.

### Chromogen

The beverage additive of the present disclosure can inhibit or reduce the binding of a chromogen in a beverage to teeth. Without wishing to be bound by any particular theory, it is believed that the beverage additive of the present disclosure binds to chromogens present in beverages, thereby preventing binding of the chromogens to teeth. By preventing the chromogens present in the beverage from binding to teeth, the subject consuming the beverage will exhibit teeth that are less stained (i.e., colored) than if the subject consumed the same beverage that does not contain the beverage additive of the present disclosure. In some embodiments, the beverage additive binds to the chromogen. Examples of chromogens include, but are not limited to, tannins, flavonoids, proanthocyanidins, aurones, chalconoids, lignans, phytoestrogens, stilbenoids, curcuminoids, betacyanins, and betaxanthins.

Examples of chromogens also include melanoidins.

Exemplary chromogens include, but are not limited to, 1,3,6-trigalloyl glucose, 1,5-dicaffeoylquinic acid, 2-s-glutathionyl caftaric acid, 3,4-dicaffeoylquinic acid, 3,5-dicaffeoylquinic acid, 3-caffeoylquinic-1 5-lactone, 4,5-dicaffeoylquinic acid, 4-O-caffeoylquinic acid, 5-caffeoylquinic acid, 5-O-caffeoylquinic acid, acacetin, apigenin, betanin, caffeic acid, carminic acid, castalagins, castalins, casuarictins, catechin, chlorogenic acid, chrysin, coumestrol, curcumin, cyanidin, cyanidin-3-glucoside, cyaniding-3,5-diglucoside, daidzein, delphinidin, delphinidin-3,5-diglucoside, delphinidin-3-glucoside, digalloyl glucose, dihydrokaempferol-3-O-α-L-rhamnopyranoside, dihydroquercetin-3-O-α-L-rhamnopyranoside, diosmetin, ellagic acid, epicatechin, epicatechin 3-gallate, epigallocatechin, epigallocatechin gallate, eriodictyol, fisetin, gallic acid, gallocatechin, gallocatechol, genistein, glycitein, grandinins, hesperidin, hexahydroxydiphenic acid, indicaxanthin, isobetanin, isorhamnetin, isorhamnetin-3-O-β-D-glucopyranoside, kaempferol, lariciresinol, luteolin, malvidin, malvidin-3,5-diglucoside, malvidin-3-glucoside, matairesinol, myricetin, myricetin, naringenin, neobetanin, oenin, pedunculagin, pelargonidin, pelargonidin-3,5-diglucoside, pelargonidin-3-glucoside, peonidin, petunidin, phenylcarboxylic acid, piceatannol, pinoresinol, pinosylvin, olyhydric alcohol, proanthocyanidins. probetanin, pterostilbene, punicalagins, punicalins, quercetin, quercetin-3-O-β-D-galactopyranoside, quercetin-3-O-β-D-glucuropyranoside, resveratrol, roburin A, rutin, rutine, secoisolariciresinol, silybin, silymarin, syringetin-3-O-β-D-glucopyranoside, tangeritin, tannic acid, tellimagrandin II, terflavin B, theaflavin, theaflavin-3,3-digallate, theaflavin-3-gallate, thearubigins, theasinensin a, vescalagins, and vulgaxanthin.

Other exemplary chromogens include compounds that can be found in beverages such as coffee, tea, wine, cola soda, and fruit juices that include, but are not limited to, 1,5-dicaffeoylquinic acid, 2-s-glutathionyl caftaric acid, 3,4-dicaffeoylquinic acid, 3,5-di-affeoylquinic acid, 3-caffeoylquinic-1 5-lactone, 4,5-dicaffeoylquinic acid, 4-O-caffeoylquinic acid, 5-caffeoylquinic acid, 5-O-caffeoylquinic acid, caffeic acid, carminic acid, catechin, chlorogenic acid, cyanidin, cyanidin-3-glucoside, cyaniding-3,5-diglucoside, delphinidin, delphinidin-3,5-diglucoside, delphinidin-3-glucoside, dihydrokaempferol-3-O-α-L-rhamnopyranoside, dihydroquercetin-3-O-α-L-rhamnopyranoside, ellagic acid, epicatechin gallate, epigallocatechin, epigallocatechin gallate, gallic acid, gallocatechol, hexahydroxydiphenic acid, isorhamnetin-3-O-β-D-glucopyranoside, malvidin, malvidin-3,5-diglucoside, malvidin-3-glucoside, myricetin, oenin, pedunculagin, pelargonidin, pelargonidin-3,5-diglucoside, pelargonidin-3-glucoside, peonidin, petunidin, phenylcarboxylic acid, polyhydric alcohol, punicalagin, punicalin, quercetin, quercetin-3-O-β-D-galactopyranoside, quercetin-3-O-β-D-glucuropyranoside, resveratrol, rutine, syringetin-3-O-β-D-glucopyranoside, tannic acid, theaflavin, theaflavin-3,3-digallate, theaflavin-3-gallate, or theasinensin A.

In some embodiments, the chromogen is a tannin. In some embodiments, the tannin is a hydrolysable tannin, a condensed tannin, a phlorotannin, or a flavono-ellagitannin. In some embodiments, the tannins are gallic acid-derived, phlorogluncinol-derived, or flavan-3,4-diol-derived. In some embodiments, the tannin is punicalagins, castalagins, vescalagins, castalins, casuarictins, grandinins, punicalins, roburin A, tellimagrandin II, terflavin B, digalloyl glucose, or 1,3,6-trigalloyl glucose. In some embodiments, the beverage additive inhibits or reduces the binding of a tannin in a beverage to teeth. In some embodiments, the beverage additive binds to a tannin in a beverage.

### Exemplary Beverage Additives and Beverage Compositions

Provided in the present disclosure are beverage additives that contain one or more components that can bind to chromogens in beverages, thereby inhibiting or reducing the amount of binding of chromogens to teeth, for example, the teeth of a subject that consumes the beverage. In some embodiments, the prevention of binding of the chromogens to the teeth of the subject reduces or inhibits staining (or coloring) of the teeth. In some embodiments, a beverage that contains the beverage additive of the present disclosure will stain teeth less or not at all in a subject that consumes the beverage as compared to consuming the same beverage that does not contain the beverage additive.

In some embodiments, the beverage additive contains a complexing agent, a thickening agent, and a preservative. In some embodiments, the beverage additive contains about 0.2 wt % to about 10 wt % of a complexing agent, about 0.2 wt % to about 3 wt % of a thickening agent, and about 0.05 wt % to about 2 wt % of a preservative. In some embodiments, the beverage additive contains about 0.2 wt % to about 10 wt %, about 0.5 wt % to about 8.0 wt %, about 0.7 wt % to about 7.0 wt %, or about 0.9 wt % to about 7.0 wt % of a complexing agent, about 0.2 wt % to about 3 wt %, about 0.3 wt % to about 2.8 wt %, about 0.3 wt % to about 2.5 wt %, or about 0.4 wt % to about 2.0 wt % of a thickening agent, and about 0.05 wt % to about 2 wt %, about 0.08 wt % to about 1.5 wt %, about 0.1 wt % to about 1.0 wt %, or about 0.2 wt % to about 0.5 wt % of a preservative. In some embodiments, the beverage additive includes water. In some embodiments, the beverage additive contains one or more of an acidulant, a sweetener, and combinations thereof. In some embodiments, the beverage additive inhibits or reduces the binding of a chromogen in a beverage to teeth. In some embodiments, the chromogen is present in a beverage selected from the group consisting of wine, coffee, tea, cola soda, and fruit juice.

Thus, provided in the present disclosure are beverage additives. The beverage additives can be added to a beverage that contains chromogens to form a beverage composition. In some embodiments, the beverage composition is consumed by a subject. In some embodiments, consuming the beverage composition inhibits or reduces binding of chromogens to the subject's teeth. In some embodiments, the inhibition or reduction in binding of chromogen results in teeth that are less stained (i.e., colored) as compared the teeth of a subject that has consumed the same beverage but without the beverage additive.

In some embodiments, the beverage additive contains tricalcium phosphate, guar gum, potassium sorbate, sodium benzoate, sodium chloride, sorbitol, and distilled water. In some embodiments, the beverage additive contains sodium tripolyphosphate, guar gum, potassium sorbate, sodium benzoate, sodium chloride, sorbitol, and distilled water. In some embodiments, the beverage additive contains magnesium chloride, guar gum, potassium sorbate, sodium benzoate, sodium chloride, sorbitol, and distilled water. In some embodiments, the beverage additive contains magnesium chloride, tricalcium phosphate, sodium tripolyphosphate, guar gum, potassium sorbate, sodium benzoate, sodium chloride, sorbitol, and distilled water. In some embodiments, the beverage additive contains tricalcium phosphate, sodium tripolyphosphate, guar gum, sodium benzoate, and distilled water.

In some embodiments, the beverage additive contains about 0.5 wt % to about 7.0 wt % of an complexing agent selected from magnesium chloride, tricalcium phosphate, sodium tripolyphosphate, and combinations thereof, about 0.3 wt % to about 2.5 wt % of a thickening agent that is guar gum, and about 0.1 wt % to about 1 wt % of a preservative selected from potassium sorbate, sodium benzoate, sodium chloride, and combinations thereof.

In some embodiments, the beverage additive contains about 0.5 wt % to about 7.0 wt % of an complexing agent selected from magnesium chloride, tricalcium phosphate, sodium tripolyphosphate, and combinations thereof, about 0.3 wt % to about 2.5 wt % of a thickening agent that is guar gum, about 0.1 wt % to about 1 wt % of a preservative selected from potassium sorbate, sodium benzoate, sodium chloride, and combinations thereof, about 90.0 wt % to about 98.0 wt % water, about 0.05 wt % to about 0.3 wt % of an acidulant selected from citric acid, malic acid, and combinations thereof, and about 0.1 wt % to about 1.5 wt % of a sweetener selected from sorbitol, potassium acesulfame, and combinations thereof.

In some embodiments, the beverage additive contains about 0.5 wt % to about 1.5 wt % magnesium chloride, about 0.5 wt % to about 1.5 wt % guar gum, about 0.05 wt % to about 0.5 wt % potassium sorbate, about 0.05 wt % to about 0.5 wt % sodium benzoate, about 0.05 wt % to about 0.5 wt % sodium chloride, about 0.05 wt % to about 0.5 wt % citric acid, about 0.05 wt % to about 0.5 wt % malic acid, about 0.5 wt % to about 1.5 wt % sorbitol, and about 95.5 wt % to about 97.5 wt % distilled water.

In some embodiments, the beverage additive contains about 1 wt % magnesium chloride, about 1 wt % guar gum, about 0.1 wt % potassium sorbate, about 0.1 wt % sodium benzoate, about 0.1 wt % sodium chloride, about 0.2 wt % citric acid, about 0.1 wt % malic acid, and about 1 wt % sorbitol. In some embodiments, the beverage additive contains about 96 wt % to about 97 wt % distilled water.

In some embodiments, the beverage additive contains about 0.5 wt % to about 1.5 wt % tricalcium phosphate, about 0.5 wt % to about 1.5 wt % guar gum, about 0.05 wt % to about 0.5 wt % potassium sorbate, about 0.05 wt % to about 0.5 wt % sodium benzoate, about 0.05 wt % to about 0.5 wt % sodium chloride, about 0.05 wt % to about 0.5 wt % citric acid, about 0.05 wt % to about 0.5 wt % malic acid, and about 0.5 wt % to about 1.5 wt % sorbitol. In some embodiments, the beverage additive contains about 96 wt % to about 97 wt % distilled water.

In some embodiments, the beverage additive contains about 1 wt % tricalcium phosphate, about 1 wt % guar gum, about 0.1 wt % potassium sorbate, about 0.1 wt % sodium benzoate, about 0.1 wt % sodium chloride, about 0.2 wt % citric acid, about 0.1 wt % malic acid, and about 1 wt % sorbitol. In some embodiments, the beverage additive contains about 96 wt % to about 97 wt % distilled water.

In some embodiments, the beverage additive contains about 0.5 wt % to about 1.5 wt % sodium tripolphosphate, about 0.5 wt % to about 1.5 wt % guar gum, about 0.05 wt % to about 0.5 wt % potassium sorbate, about 0.05 wt % to about 0.5 wt % sodium benzoate, about 0.05 wt % to about 0.5 wt % sodium chloride, about 0.05 wt % to about 0.5 wt % citric acid, about 0.05 wt % to about 0.5 wt % malic acid, about 0.5 wt % to about 1.5 wt % sorbitol, and about 95.5 wt % to about 97.5 wt % distilled water.

In some embodiments, the beverage additive contains about 1 wt % sodium tripolphosphate, about 1 wt % guar gum, about 0.1 wt % potassium sorbate, about 0.1 wt % sodium benzoate, about 0.1 wt % sodium chloride, about 0.2 wt % citric acid, about 0.1 wt % malic acid, and about 1 wt % sorbitol. In some embodiments, the beverage additive contains about 96 wt % to about 97 wt % distilled water.

In some embodiments, the beverage additive contains about 0.05 wt % to about 1.0 wt % magnesium chloride, about 0.05 wt % to about 1.0 wt % tricalcium phosphate, about 0.05 wt % to about 1.0 wt % sodium tripolphosphate, 0.05 wt % to about 1.0 wt % guar gum, about 0.05 wt % to about 0.5 wt % potassium sorbate, about 0.05 wt % to about 0.5 wt % sodium benzoate, about 0.05 wt % to about 0.5 wt % sodium chloride, about 0.05 wt % to about 0.5 wt % citric acid, about 0.05 wt % to about 0.5 wt % malic acid, and about 0.5 wt % to about 1.5 wt % sorbitol. In some embodiments, the beverage additive contains about 96 wt % to about 97 wt % distilled water.

In some embodiments, the beverage additive contains about 0.5 wt % magnesium chloride, about 0.5 wt % tricalcium phosphate, about 0.5 wt % sodium tripolphosphate, about 0.5 wt % guar gum, about 0.1 wt % potassium sorbate, about 0.1 wt % sodium benzoate, about 0.1 wt % sodium chloride, about 0.2 wt % citric acid, about 0.1 wt % malic acid, and about 1 wt % sorbitol. In some embodiments, the beverage additive contains about 96 wt % to about 97 wt % distilled water.

In some embodiments, the beverage additive contains about 0.1 wt % to about 2 wt % tricalcium phosphate, about 4.5 wt % to about 6.5 wt % sodium tripolphosphate, about 1.0 wt % to about 3.0 wt % guar gum, about 0.05 wt % to about 1.5 wt % sodium benzoate, about 0.05 wt % to about 1.0 wt % sorbitol, and about 89.0 wt % to about 92.0 wt % distilled water.

In some embodiments, the beverage additive comprises about 0.9 wt % tricalcium phosphate, about 5.5 wt % sodium tripolyphosphate, about 1.8 wt % guar gum, about 0.4 wt % sodium benzoate, and about 0.2 wt % potassium acesulfame. In some embodiments, the beverage additive contains about 91 wt % to about 92 wt % distilled water.

In some embodiments, the beverage additive comprises about 80 wt % to about 95 wt % distilled water, about 7.0 wt % to about 9.0 wt % complexing agent, and about 0.1 wt % to about 3 wt % preservative.

In some embodiments, the beverage additive comprises about 80 wt % to about 95 wt % distilled water, about 7.0 wt % to about 9.0 wt % complexing agent, and about 0.1 wt % to about 1.0 wt % pH modifier.

In some embodiments, the beverage additive comprises about 80 wt % to about 95 wt % distilled water, about 7.0 wt % to about 9.0 wt % complexing agent, about 0.1 wt % to about 3 wt % preservative, and about 0.1 wt % to about 1.0 wt % pH modifier.

In some embodiments, the beverage additive comprises about 91.4 wt % distilled water, about 8.2 wt % complexing agent, and about 0.4 wt % preservative.

In some embodiments, the beverage additive comprises about 90.9 wt % distilled water, about 8.2 wt % complexing agent, and about 0.9 wt % pH modifier.

In some embodiments, the beverage additive comprises about 89.3 wt % distilled water, about 8.0 wt % complexing agent, about 1.8 wt % preservative, and about 0.9 wt % pH modifier.

In some embodiments, the beverage additive comprises about 91.4 wt % distilled water, about 5.5 wt % sodium tripolyphosphate, about 1.8 wt % guar gum, about 0.9 wt % tricalcium phosphate, and about 0.4 wt % sodium benzoate.

In some embodiments, the beverage additive comprises about 91.4 wt % distilled water, about 5.5 wt % sodium tripolyphosphate, about 1.8 wt % guar gum, about 0.9 wt % tricalcium phosphate, and about 0.4 wt % potassium sorbate.

In some embodiments, the beverage additive comprises about 91.4 wt % distilled water, about 5.5 wt % sodium tripolyphosphate, about 1.8 wt % guar gum, about 0.9 wt % tricalcium phosphate, and about 0.4 wt % calcium propionate.

In some embodiments, the beverage additive comprises about 91.4 wt % distilled water, about 5.5 wt % sodium tripolyphosphate, about 1.8 wt % guar gum, about 0.9 wt % tricalcium phosphate, and about 0.4 wt % sodium metabisulfite.

In some embodiments, the beverage additive comprises about 90.9 wt % distilled water, about 5.5 wt % sodium tripolyphosphate, about 1.8 wt % guar gum, about 0.9 wt % tricalcium phosphate, and about 0.9 wt % sodium bicarbonate.

In some embodiments, the beverage additive comprises about 89.3 wt % distilled water, about 5.5 wt % sodium tripolyphosphate, about 1.8 wt % guar gum, about 0.9 wt % tricalcium phosphate, about 1.8 wt % cultured dextrose, and about 0.9 wt % sodium bicarbonate. In some embodiments, the cultured dextrose is CytoGUARD® CDP Ultra.

Also provided herein is a beverage composition that includes a beverage that contains chromogens and the beverage additive of the present disclosure. In some embodiments, the beverage additive does not change the color, aroma, or flavor of the beverage composition as compared to the same beverage that does not contain the beverage additive. In some embodiments, the beverage additive comprises about 0.001% to about 10% of the beverage composition by volume. In some embodiments, the beverage additive comprises about 0.05% to about 6.0% of the beverage composition by volume. In some embodiments, the beverage additive comprises about 0.05% to about 6.0%, about 1.0% to about 5.0%, or about 2.0% to about 4.0% of the beverage composition by volume. In some embodiments, the beverage additive comprises about 3.3% of the beverage composition by volume. In some embodiments, the beverage composition does not stain teeth. In some embodiments, the beverage composition stains teeth less than the same beverage that does not contain the beverage additive of the present disclosure. In some embodiments, the beverage composition stains teeth less than the same beverage that does not contain the beverage additive of the present disclosure after the beverage is consumed by a subject.

The beverage additive of the present disclosure can be added to any beverage that stains teeth upon consuming the beverage or being exposed to the beverage for a period of time. In some embodiments, the beverage contains chromogens. In some embodiments, the chromogens are tannins. Thus, the beverage additive can be added to beverages including, but not limited to, wine, coffee, tea, fruit juices, cola soda, carbonated beverages, and any beverage that causes teeth staining. In some embodiments, the beverage is red wine. In some embodiments, the beverage is coffee. In some embodiments, the beverage is tea. In some embodiments, the beverage is a fruit juice. In some embodiments, the beverage is a cola soda.

### Methods of Use

Additionally, provided in this disclosure is a method of inhibiting chromogen binding to teeth. In some embodiments, the chromogen is in a beverage. In some embodiments, the method inhibits chromogen bind to teeth as a result of beverage consumption by a subject. In some embodiments, the method includes adding the beverage additive of the present disclosure to a beverage. In some embodiments, the beverage contains chromogens. In some embodiments, the beverage is selected from the group consisting of wine, coffee, tea, cola soda, and fruit juice.

Also provided in the present disclosure is a method of inhibiting, reducing, or preventing staining of teeth by chromogens, such as from a chromogen-containing beverage. In some embodiments, the chromogen-containing beverage is consumed by a subject. In some embodiments, the method includes adding a beverage additive of the present disclosure to a beverage that contains chromogens to form a beverage composition; and consuming the beverage composition by a subject.

Also provided in the present disclosure is a method of preparing a beverage composition. In some embodiments, the method includes adding the beverage additive of the present disclosure to a beverage comprising chromogens to form the beverage composition.

### Examples

### Example 1—Preparation of Stain Prevention Additives

A series of stain prevention additives (1-6) were prepared by combining the ingredients shown in Table 1.

TABLE 1

| | Stain Prevention Additives | | | | | |
|---|---|---|---|---|---|---|
| | 1 | 2 | 3 | 4 | 5 | 6 |
| Ingredient | (%) | (%) | (%) | (%) | (%) | (%) |
| Magnesium chloride | 0 | 0 | 0 | 1 | 0.5 | 0 |
| Tricalcium phosphate | 0 | 1 | 0 | 0 | 0.5 | 0.9 |
| Sodium | 0 | 0 | 1 | 0 | 0.5 | 5.5 |
| tripolyphosphate | | | | | | |
| Guar gum | 0 | 1 | 1 | 1 | 0.5 | 1.8 |
| Potassium sorbate | 0.1 | 0.1 | 0.1 | 0.1 | 0.1 | 0 |
| Sodium benzoate | 0.1 | 0.1 | 0.1 | 0.1 | 0.1 | 0.4 |
| Sodium chloride | 0.1 | 0.1 | 0.1 | 0.1 | 0.1 | 0 |
| Sorbitol | 1 | 1 | 1 | 1 | 1 | 0 |
| Potassium acesulfame | 0 | 0 | 0 | 0 | 0 | 0.2 |
| Distilled Water | 98.7 | 96.7 | 96.7 | 96.7 | 96.7 | 91.2 |
| Total | 100% | 100% | 100% | 100% | 100% | 100% |

### Example 2—Stain Prevention from Red Wine

1 mL of each of stain prevention additives 1-8, prepared according to Example 1, was added to a separate 30 mL sample of red wine. A human tooth was placed inside each sample of wine and left for 24 hrs. After 24 hrs, the teeth were removed from the wine samples, brushed with a regular toothbrush, and the teeth colors were measured using the CIELAB color scale, a uniform color scale used for color specification and color difference evaluation. The CIELAB color scale evaluates color in terms of three axes of a color sphere, called L, a, and b. The “L” value is the axis in the color sphere which relates lightness and darkness on a scale from 0 (black) to 100 (white). The “a” value is the axis which relates color on a yellow to blue scale, with a 0 value in the center of the sphere, positive values toward the yellow, and negative values toward the blue. The “b” value is the axis which relates color on a red to green scale, with a 0 value in the center of the sphere, positive values toward the red, and negative values toward the green.

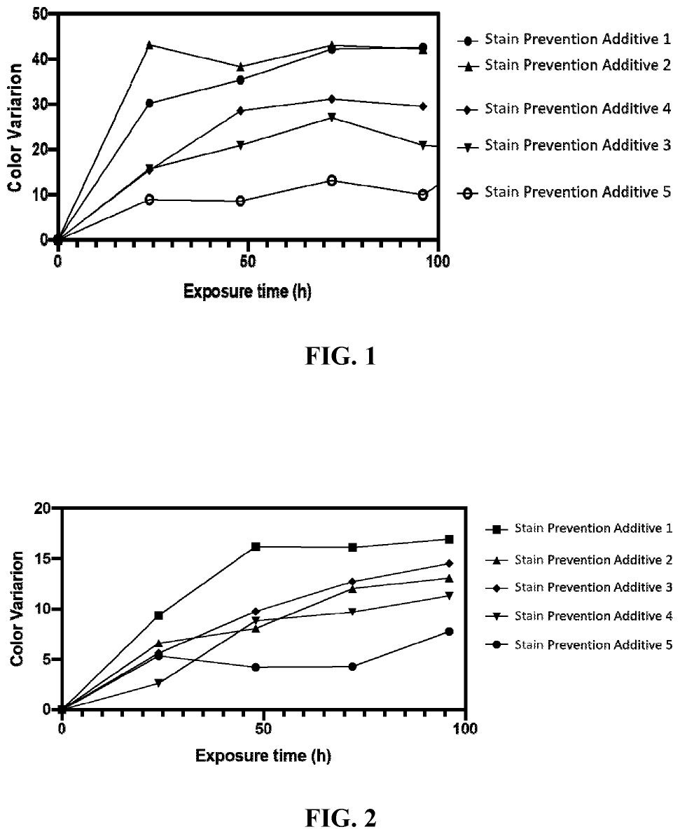

Each tooth was then placed in a fresh 30 mL sample of red wine with the respective 1 mL of additive 1-8 for another 24 hrs. This procedure was repeated for a total of 96 hrs. Color variation—delta E, was determined by comparing the parameters a*, b* and L for the teeth at 0 hrs to the teeth after a specific period of time according to Equation (1). The results are shown in Table 2 and FIG. 1.

ΔE=[(ΔL*)²+(Δa*)²+(Δb*)²]₂¹ Equation (1):

TABLE 2

| | Stain Prevention Additive | | | | |
|---|---|---|---|---|---|
| Time Elapsed (hours) | 1 | 2 | 3 | 4 | 5 |
| 24 | 30.3 | 43.2 | 15.8 | 15.4 | 8.9 |
| 48 | 35.4 | 38.4 | 20.9 | 28.6 | 8.7 |
| 72 | 42.3 | 43.1 | 27.0 | 31.2 | 13.2 |
| 96 | 42.6 | 42.3 | 20.9 | 29.5 | 10.0 |

### Example 3—Stain Prevention from Black Coffee

1 mL of each of stain prevention additives 1-8, prepared according to Example 1, was added to a separate 30 mL sample of coffee. A human tooth was placed inside each sample of coffee and left for 24 hrs. After 24 hrs, the teeth were removed from the coffee samples, brushed with a regular toothbrush, and the teeth colors were measured using the CIELAB color space. Each tooth was then placed in a fresh 30 mL sample of coffee with the respective 1 mL of additive 1-8 for another 24 hrs. This procedure was repeated for a total of 96 hrs. Color variation—delta E, was determined by comparing the parameters a*, b* and L for the teeth at 0 hrs to the teeth after a specific period of time. The results are shown in Table 3 and FIG. 2.

TABLE 3

Stain Prevention Additive

| Time Elapsed (hrs) | 1 | 2 | 3 | 4 | 5 |
|---|---|---|---|---|---|
| 24 | 9.37 | 6.61 | 2.62 | 5.62 | 5.34 |
| 48 | 16.20 | 8.05 | 8.83 | 9.76 | 4.23 |
| 72 | 16.13 | 12.03 | 9.69 | 12.73 | 4.29 |
| 96 | 16.94 | 13.09 | 11.31 | 14.5 | 7.78 |

### Example 7—Concentration Effect of Staining Prevention Solution

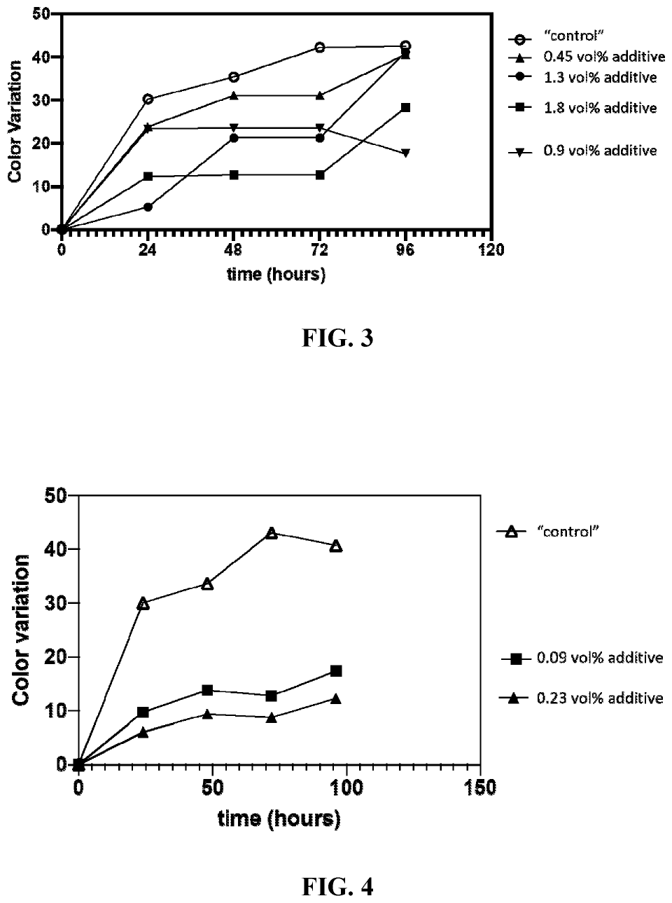

To four cups with 55 mL of wine was added 0.25 mL, 0.5 mL, 0.75 mL, and 1 mL, respectively, of stain prevention additive 5. To a fifth cup with 55 mL of wine was added 1 mL of stain prevention additive 1 (designated “control”). A human tooth was placed inside each cup of wine with a different staining prevention solution and left for 24 hrs. After 24 hrs, all teeth were taken out, brushed with a regular toothbrush and its colors were measured under the CIELAB space color. Each tooth was placed in a fresh cup of 55 mL of red wine with the respective quantity of staining prevention solution for another 24 hrs. This procedure was repeated until 96 hrs were completed. Color variation—delta E, was determined by comparing the parameters a*, b* and L for the teeth at 0 hrs to the teeth after a specific period of time. The results are shown in Table 4 and FIG. 3.

TABLE 4

Additive 5 (vol %)

| Time Elapsed (hrs) | 0.45 | 0.90 | 1.3 | 1.8 |
|---|---|---|---|---|
| 24 | 23.84 | 23.37 | 5.23 | 12.32 |
| 48 | 31.15 | 23.55 | 21.27 | 12.74 |
| 72 | 31.15 | 23.55 | 21.27 | 12.74 |
| 96 | 40.66 | 17.65 | 41.22 | 28.31 |

### Example 8—Stain Prevention with Increased Complexing Agent

To two cups with 55 mL of wine was added 0.05 mL and 0.125 mL, respectively, of stain prevention additive 6. To a third cup with 55 mL of wine was added 1 mL of stain prevention additive 1 (designated “control”). A human tooth was placed inside each cup of coffee with a different staining prevention solution and left for 24 hrs. After 24 hrs, all teeth were taken out, brushed with a regular toothbrush and its colors were measured under the CIELAB space color. Each tooth was placed in a fresh cup of 30 mL of coffee with the respective 1 mL of staining prevention solution for another 24 hrs. This procedure was repeated until 96 hrs were completed. Color variation—delta E, was determined by comparing the parameters a*, b* and L for the teeth at 0 hrs to the teeth after a specific period of time. The results are shown in Table 5 and FIG. 4.

TABLE 5

Additive 6 (vol %)

| Time Elapsed (hrs) | 0.09 | 0.23 |
|---|---|---|
| 24 | 9.73 | 6.01 |
| 48 | 13.80 | 9.41 |
| 72 | 12.76 | 8.76 |
| 96 | 17.34 | 12.26 |

### Example 9—Preparation of Stain Prevention Additives 7-12

A series of stain prevention additives (7-12) were prepared by combining the ingredients shown in Table 6.

TABLE 6

| | Stain Prevention Additives | | | | | |
|---|---|---|---|---|---|---|
| | 7 | 8 | 9 | 10 | 11 | 12 |
| Ingredient | (wt %) | (wt %) | (wt %) | (wt %) | (wt %) | (wt %) |
| Water | 91.4 | 91.4 | 91.4 | 91.4 | 90.9 | 89.3 |
| Sodium tri- | 5.5 | 5.5 | 5.5 | 5.5 | 5.5 | 5.4 |
| polyphosphate | | | | | | |
| Guar gum | 1.8 | 1.8 | 1.8 | 1.8 | 1.8 | 1.8 |
| Tricalcium | 0.9 | 0.9 | 0.9 | 0.9 | 0.9 | 0.9 |
| phosphate | | | | | | |
| Sodium | 0.4 | 0.0 | 0.0 | 0.0 | 0.0 | 0.0 |
| benzoate | | | | | | |
| Potassium | 0.0 | 0.4 | 0.0 | 0.0 | 0.0 | 0.0 |
| sorbate | | | | | | |
| Calcium | 0.0 | 0.0 | 0.4 | 0.0 | 0.0 | 0.0 |
| propionate | | | | | | |
| Sodium | 0.0 | 0.0 | 0.0 | 0.4 | 0.0 | 0.0 |
| metabisulfite | | | | | | |
| Sodium | 0.0 | 0.0 | 0.0 | 0.0 | 0.9 | 0.9 |
| bicarbonate | | | | | | |
| Cytoguard | 0.0 | 0.0 | 0.0 | 0.0 | 0.0 | 1.8 |
| CDP ultra | | | | | | |
| (modified | | | | | | |
| dextrose) | | | | | | |

### Example 10—Shelf Life

The stability of stain prevention additives 7-12 was tested. Stain prevention additives 7-9 were unsuccessful, possibly because the pH was too high. Stain prevention additive 10 was stable for 6 months. Stain prevention additive 11 was stable for 2 months and stain prevention additive 12 was stable for 6 months.

### OTHER EMBODIMENTS

It is to be understood that the foregoing description is intended to illustrate and not limit the scope of the disclosure, which is defined by the scope of the appended claims. Other aspects, advantages, and modifications are within the scope of the following claims.

What is claimed is:

1. A beverage additive comprising:
about 0.2 wt % to about 10 wt % of a complexing agent;
about 0.2 wt % to about 3 wt % of a thickening agent; and
about 0.05 wt % to about 2 wt % of a preservative;
wherein the beverage additive inhibits or reduces the binding of a chromogen in a beverage to teeth.

2. The beverage additive of claim 1, wherein the chromogen is present in a beverage selected from the group consisting of wine, coffee, tea, cola soda, and fruit juice.

3. The beverage additive of claim 1, wherein the chromogen is selected from the group consisting of a tannin, a flavonoid, a proanthocyanidin, an aurone, a chalconoid, a lignan, a phytoestrogen, a stilbenoid, a curcuminoid, a betacyanin, and a betaxanthin.

4. The beverage additive of claim 1, wherein the complexing agent is an inorganic salt or an organic salt.

5. The beverage additive of claim 1, wherein the complexing agent is selected from the group consisting of tricalcium phosphate, dicalcium phosphate, calcium chloride, calcium carbonate, sodium phosphate, sodium chloride, sodium bicarbonate, sodium tripolyphosphate, magnesium chloride, potassium chloride, citric acid, malic acid, lactic acid, acetic acid, phosphoric acid, hydrochloric acid, hydroxide sodium, iron (III) chloride, and combinations thereof.

6. The beverage additive of claim 1, comprising about 0.5 wt % to about 7 wt % complexing agent.

7. The beverage additive of claim 1, wherein the thickening agent is a polysaccharide.

8. The beverage additive of claim 1, wherein the thickening agent is selected from the group consisting of guar gum, xantham gum, gellan gum, konjac mannan, arabic gum, hydropropymethyl cellulose, carboxymethyl cellulose, methyl cellulose, chitosan, alginate, carrageenan, and combinations thereof.

9. The beverage additive of claim 1, comprising about 0.5 wt % to about 2 wt % thickening agent.

10. The beverage additive of claim 1, wherein the preservative is selected from the group consisting of potassium sorbate, sodium benzoate, sodium chloride, benzoic acid, calcium sorbate, erthorbic acid, potassium nitrate, and combinations thereof.

11. The beverage additive of claim 1, comprising about 0.3 wt % to about 0.4 wt % preservative.

12. The beverage additive of claim 1, further comprising water.

13. The beverage additive of claim 12, comprising about 80 wt % to about 99.5 wt % water.

14. The beverage additive of claim 1, further comprising a sweetener.

15. The beverage additive of claim 14, wherein the sweetener is selected from the group consisting of potassium acesulfame, sucralose, allulose, cane sugar, brown sugar, molasses, stevia, sorbitol, mannitol, xylitol, lactitol, maltitol, isomalt, laycasin, and combinations thereof.

16. The beverage additive of claim 14, comprising about 0.05 wt % to about 2.0 wt % sweetener.

17. The beverage additive of claim 1, further comprising a pH modifier.

18. A method of inhibiting chromogen binding to teeth from beverage consumption in a subject, comprising:
adding the beverage additive of claim 1 to a beverage comprising chromogens, and
consuming the beverage comprising the beverage additive by the subject.

19. A beverage composition, comprising a beverage comprising chromogens and the beverage additive of claim 1.

20. A method of preparing a beverage composition, comprising adding the beverage additive of claim 1 to a beverage comprising chromogens to form a beverage composition.
